(19) United States
(12) Patent Application Publication
(10) Pub. No.: US 2021/0317778 A1
(43) Pub. Date: Oct. 14, 2021

(54) VALVE

(71) Applicant: Vitesco Technologies GmbH, Hannover (DE)

(72) Inventors: Stefan Oskar GRÜNEIS, Schwalbach a. Ts. (DE); Rosario BONANNO, Schwalbach a. Ts. (DE); Joachim VON WILLICH, Schwalbach a. Ts. (DE)

(21) Appl. No.: 17/271,834

(22) PCT Filed: May 20, 2019
(86) PCT No.: PCT/EP2019/062932

§ 371 Date: Feb. 26, 2021

(30) Foreign Application Priority Data
Aug. 27, 2018 (DE) 10 2018 214 460.5

(51) Int. Cl. F02B 37/18; F16K 31/06

(52) U.S. Cl. CPC F02B 37/186; F16K 31/0655; F05D 2260/606; F05D 2270/62; F05D 2220/40

(57) ABSTRACT

Valve for blocking and releasing a flow path, having an electromagnetic actuator unit, an armature movable by the electromagnetic actuator unit, and a closure element connected to the armature. The closure element blocks and releases a flow path. A housing receives the armature and a first axial end of the closure element, a housing part forms a valve seat and against which a second axial end of the closure element is pressed by a spring device in a closed position of the valve. The spring device has at least one spring compressible at a first spring rate starting from a fully closed position of the valve to a partially open intermediate position of the valve, and a spring compressible at a second spring rate starting from a partially open intermediate position of the valve to a fully open position of the valve.

### CROSS REFERENCE TO RELATED APPLICATIONS

This is a U.S. national stage of Application No. PCT/EP2019/062932 filed May 20, 2019. Priority is claimed on German Application No. DE 10 2018 214 460.5 filed Aug. 27, 2018 the content of which is incorporated herein by reference.

### BACKGROUND OF THE INVENTION

### 1. Field of the Invention

The present invention concerns a valve that can be actuated by an electromagnetic actuator unit for blocking and releasing a flow path.

### 2. Description of Related Art

Such valves are used, for example, as recirculation dump valves on the turbocharger in motor vehicles r to open a bypass to an intake side in overrun operation. To prevent excessive braking of the turbine of the turbocharger at low rotation speeds, but also to guarantee rapid run-up, fast opening and closing processes of the valve are desired.

Typically, valves on turbochargers are configured either as flap valves actuated by a drive motor with gear mechanism, or as slide or piston valves. Diaphragm valves are also commonly used. Flap valves have the advantage that they allow intermediate positions of the flap, which can be set using corresponding sensors and allow partial opening of the bypass line. This however requires significant technical complexity.

Slide or piston valves have the advantage that they are particularly simple in structure and hence low-cost, and also have good response behaviour. However, conventionally they only allow a fully closed or fully open position.

### SUMMARY OF THE INVENTION

One aspect of the invention is specifying a valve for blocking and opening a flow path, which is suitable for use as a recirculation dump valve on a turbocharger of a motor vehicle, and which at the same time has a simple structure, works reliably and allows reliable control of the mass flow in a bypass line.

According to one aspect of the invention, a valve is provided for blocking and releasing a flow path, which has an electromagnetic actuator unit and an armature that can be axially moved by the electromagnetic actuator unit in the direction of a longitudinal axis of the valve, and a closure element connected to the armature, wherein the closure element is designed to block and release a flow path. Furthermore, the valve comprises a housing that receives at least the armature and a first axial end of the closure element connected to the armature, and a housing part that forms a valve seat and against which a second axial end of the closure element is pressed by a spring device in a closed position of the valve.

The spring device has at least one spring that can be compressed at a first spring rate starting from a fully closed position of the valve up to a partially open intermediate position of the valve, and a spring that can be compressed at a second spring rate starting from a partially open intermediate position of the valve up to a fully open position of the valve. The first spring rate here differs from the second spring rate.

The spring rate of the spring, also known as the spring stiffness, spring hardness or spring constant, gives the ratio of the force acting on a spring to the resulting deflection of the spring. It depends on various factors, in particular the material and type of spring used.

The valve has the advantage that, in a technically particularly simple fashion, it allows the closure element to assume intermediate positions in which the flow path is partially blocked, so that a mass flow, which is reduced in comparison with the fully open position, flows through the bypass line.

The intermediate position is achieved in that the spring device is compressible at different spring rates, wherein in particular the second spring rate is greater than the first spring rate; i.e. starting from a fully closed position of the valve, the spring is initially compressible by a relatively low first force up to a partially open intermediate position, and the fully open position of the valve can only be reached if a second force acts on the spring, which is greater than the first force.

Advantageously, the electromagnetic actuator unit may then be actuated to initially provide a relatively low first force F1 on the armature and hence on the spring compressed by the closure element. The first force F1 is here dimensioned such that it is sufficient to overcome the counter-force exerted by the spring at the first spring rate, but not the counter-force exerted by the spring at the second spring rate. Thus for the first force F1:

D1·ΔL1≤F1<D2·ΔL2,

wherein D1 and D2 are the first and second spring rates, and ΔL1 and ΔL2 are a deflection of the spring device under the influence of the magnetic force, wherein in particular ΔL1 means the deflection of the spring device until reaching the desired intermediate position.

Such actuation causes the closure element to move only to the partially open intermediate position.

Only when a sufficiently high second force F2 is applied, in particular by the application of a higher voltage or a corresponding pulse width modulation of the voltage, can the closure element be moved from the intermediate position into the fully open position. This higher second force is dimensioned so as to be sufficient to overcome the force exerted by the spring at the second spring rate.

The valve therefore has the advantage that, in a particularly simple fashion, it allows the closure element to assume intermediate positions. Technically complex devices, such as for example sensors, may be omitted. The intermediate positions are predefined by the selection of corresponding spring rates, and the electromagnetic actuator unit is actuated accordingly. The different spring rates achieve a particularly clear pre-definition of the intermediate positions and a particularly precise positioning of the closure element.

According to one aspect of the invention, several springs with different spring rates are used for the spring device. The spring device here has at least a first spring, which is compressible at the first spring rate, and a second spring, which is compressible at the second spring rate. In this case, there is a jump in the force required for moving the closure element, because in a first step initially the first spring must be compressed until reaching the intermediate position in which the second spring is not yet compressed but already begins to exert a counter-force on the closure element. In order then to open the valve further, the electromagnetic actuator unit must apply a higher force since now a higher counter-force of the spring device must be overcome.

In particular, the first and second spring may be arranged coaxially, and in particular configured as coil springs arranged symmetrically around a longitudinal axis of the valve. With such an arrangement, the two springs can be switched in parallel between the intermediate position and the fully open position, and the return forces exerted on the closure element are cumulated. Such an arrangement has the advantage that it requires little installation space.

Alternatively, the two springs or several springs may be connected in series.

With parallel connection of the springs, in particular the second spring may have a smaller diameter than the first spring, i.e. be arranged inside the first spring. However, a reverse arrangement is conceivable in which the first spring has a smaller diameter than the second spring, which is the more advantageous embodiment depends for example on the design of the closure element.

According to one aspect of the invention, the first spring is supported on a base of the closure element and the second spring is supported on a collar inside the first spring and concentric thereto, wherein the collar is axially displaceable. A stop, for example in the form of a circumferential or partially circumferential web, is arranged on the base of the closure element and is in contact with the collar during compression of the second spring.

In this embodiment, which is particularly simple and compact, the first spring is compressed when the electromagnetic actuator unit provides a first magnetic force. An intermediate position is reached when the closure element has moved axially so far that the stop comes into contact with the collar. In this intermediate position, the second spring begins to exert a counter-force on the closure element via the collar and the stop, which force can only be overcome by a correspondingly increased magnetic force.

The spring device may however also have a single spring composed so as to be compressible at different spring rates. For example, a spring with a progressive winding may be used.

According to one aspect of the invention, the spring device comprises a single spring that can be compressed at a first spring rate up to an intermediate position and then at a second spring rate, wherein in particular the first spring rate is smaller than the second spring rate.

A continuous increase in spring rates is also conceivable, and/or more than two different spring rates.

According to one aspect of the invention, the actuator unit may be actuated to exert either a first force F1 or a second force F2 on the armature, wherein F1 is not equal to F2.

According to one aspect of the invention, a motor vehicle is indicated with a turbocharger device comprising an intake side with a compressor and a turbine side with a turbine, wherein a bypass line to the compressor is arranged on the intake side, wherein the described valve is arranged in the bypass line for releasing or blocking the bypass line.

### BRIEF DESCRIPTION OF THE DRAWINGS

Embodiments of the invention will now be explained in greater detail with reference to the accompanying figures.

FIG. 1 is diagrammatically, in longitudinal section, a valve in a closed position;

FIG. 2 is the valve from FIG. 1 in a partially open intermediate position; and

FIG. 3 is diagrammatically the valve from FIG. 1 in a fully open position.

### DETAILED DESCRIPTION OF THE PRESENTLY PREFERRED EMBODIMENTS

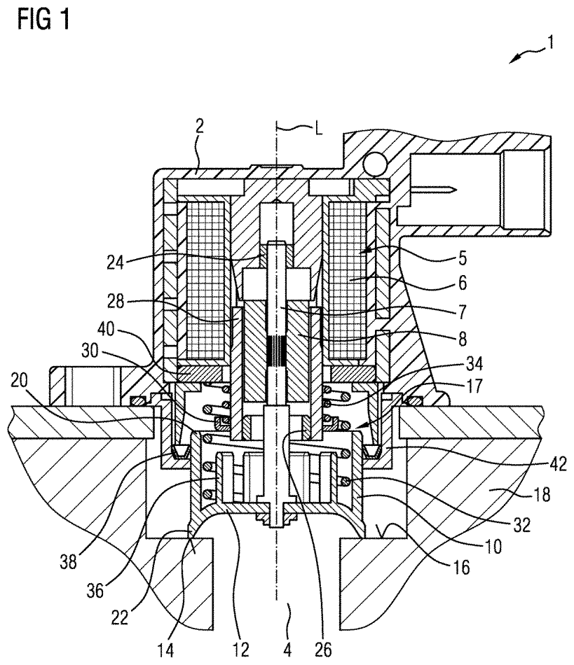

FIG. 1 shows a valve 1, configured as a recirculation dump valve for a turbocharger (not shown) of a vehicle, according to one aspect of the invention, in a closed position. The valve 1 is shown in FIG. 1, as in all figures, in longitudinal section, i.e. cut parallel to a longitudinal axis of the valve.

The valve 1 comprises a housing 2 with an integrally formed flange having bores, via which the housing 2 is flanged-mounted on the turbocharger (not shown) in a region of a bypass line 4. In the installed position shown, the housing 2 is adjoined by a second housing part 13 of the valve 1.

Alternatively, the housing part 13 and the further housing part 18 may be formed integrally with the housing 2.

An electromagnetic actuator unit 5 having a coil 6 and a metal pin 7 connected to an armature 8 is arranged in the housing 2. The pin 7 is mounted by means of an upper bearing 24 and a lower bearing 26 so as to be axially displaceable in the housing 2, and is fixedly connected to a pot-like closure element 10.

The pot-like closure element 10, serving as a piston, cooperates with a valve seat 12 to block or release the bypass line 4. For this, the closure element 10 has an annular sealing face 14, which cooperates with a valve seat 16 to close off the cross-section of the bypass line 4. A spring device 17 presses the closure element 10 in the direction of the valve seat 16. When the valve 1 is not actuated, the force generated by the spring device 17 is countered only by the force acting on the base 12 of the closure element 10 owing to the pressure in the line 4.

The closure element 10 is sealed against the housing part 42 by an annular seal 38 with V-shaped profile.

In the embodiment shown, the spring device 17 has a first spring 32 and a second spring 34. The first spring 32 and the second spring 34 are arranged coaxially to the longitudinal axis L of the valve 1 and configured as coil springs, wherein the second spring 34 has a smaller diameter than the first spring 32 and is arranged inside the first spring 32. The first spring 32 and the second spring 34 have spring rates D1 and D2 respectively.

The second spring 34 is formed shorter than the first spring 32. The first spring 32 is supported at one end on the base 12 of the closure element 10 and the other end on a ring disc 40, which is arranged in the housing 2 coaxially to the longitudinal axis L. The second spring 34 is also supported at one end on the ring disc 40, but at its other end on a collar 30 held by a guide sleeve 28.

The guide sleeve 28 is arranged so as to be axially displaceable in the housing 2, concentrically to the pin 7 and armature 8. The guide sleeve 28 is also arranged so as to be axially displaceable relative to the pin 7 and armature 8. Its purpose is to hold the lower bearing 26 and also support the collar 30.

A stop 36, in the form of a partially interrupted, radially peripheral web, is arranged on the base 12 of the closing element 10 coaxially to the longitudinal axis L. The distance from the stop 36 to the longitudinal axis L substantially corresponds to the distance of the collar 30 from the longitudinal axis L, so that by displacement of the closure element 10 in the axial direction, the stop 36 can be brought into contact with the collar 30.

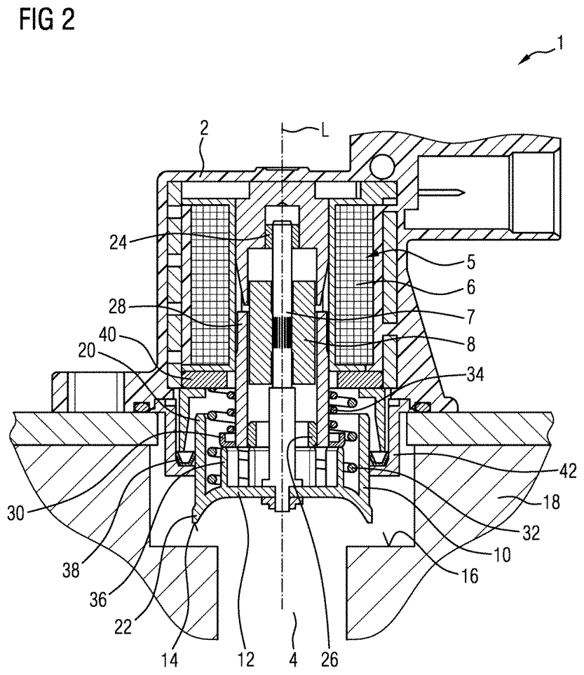

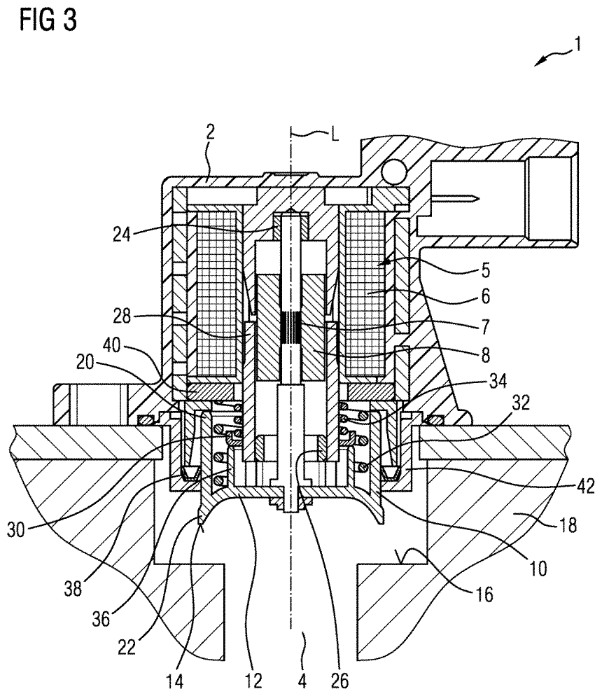

The two springs 32, 34 together form the spring device 17. The spring device 17 has two different spring rates in the embodiment shown. When the spring device 17 is compressed, starting from the closed position of the valve 1 shown in FIG. 1, the spring rate D1 of the first spring 32 is active because initially only this spring 32 is compressed. If the valve 1 is opened further however, beyond a defined intermediate position, at the same time also the second spring 34 is compressed, so that in total the spring constants D1+D2 are applied. This process is now described in more detail on the basis of FIGS. 2 and 3.

FIG. 2 shows the valve 1 from FIG. 1 in a partially open position in which the bypass line 4 is partially released, i.e. a reduced mass flow through this is possible. In order to reach the partially open position, a voltage was applied to the magnetic coil 6, which resulted in a magnetic force that was sufficient to compress the first spring 32. Then the valve 1 opened until the stop 36 came to rest on the underside of the collar 30. This position is illustrated in FIG. 2.

In this position however the axial movement of the closure element 10 stops, since for further opening of the valve 1, not only must the counter-force of the first spring 32 be overcome, but also the further counter-force of the second spring 34, which is now connected in parallel. Because of the contact between the stop 36 and the collar 30, for further opening of the valve, both springs 32, 34 must now be compressed, for which a greater magnetic force is required.

If the bypass line 4 is to be only partially opened, therefore a voltage is applied to the coil 6, which is sufficient to overcome the counter-force of the first spring 32 and reach the intermediate position shown in FIG. 2, but which is too small to overcome the additional counter-force of the second spring 34 and reach the fully open position shown in FIG. 3.

In order to reach the fully open position of the valve 1 shown in FIG. 3, starting from the intermediate position shown in FIG. 2, then a higher magnetic force is provided by the actuator unit 5. For this, for example, a higher voltage is applied. If the force is sufficient to overcome the counter-force provided by the two springs 32, 34, which are now connected in parallel, the closure element 10 moves in the axial direction until it completely releases the bypass line 4. This position of the valve 1 is illustrated in FIG. 3.

The valve 1 thus allows not only a fully closed and a fully open position, but also an intermediate position. If the spring device 17 is configured to have more than two different spring constants, further intermediate positions are also conceivable, between which typically the spring constant rises in steps.

The electromagnetic actuator unit 5 is actuated accordingly to overcome the respective counter-force of the spring device 17. In this way, by an electromagnetic valve and while omitting position sensors, it is possible to provide a recirculation dump valve which has one or more defined intermediate positions of the closure element 10, which can be actuated in targeted fashion.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A valve for blocking and releasing a flow path, comprising:
an electromagnetic actuator unit;
an armature configured to be moved axially by the electromagnetic actuator unit;
a closure element connected to the armature and configured to block and release a flow path;
a housing that receives at least the armature and a first axial end of the closure element connected to the armature;
a spring device comprising:
at least one first spring that can be compressed at a first spring rate starting from a fully closed position of the valve up to a partially open intermediate position of the valve; and
a second spring that can be compressed at a second spring rate starting from a partially open intermediate position of the valve up to a fully open position of the valve,
wherein the first spring rate differs from the second spring rate; and
a housing part that forms a valve seat and against which a second axial end of the closure element is pressed by a spring device in a closed position of the valve.

11. The valve as claimed in claim 10,
wherein the second spring rate is greater than the first spring rate.

12. The valve as claimed in claim 10,
wherein the spring device has at least the at least one first spring which is compressible at the first spring rate, and the second spring which is compressible at the second spring rate.

13. The valve as claimed in claim 12,
wherein the at least one first spring and the second spring are arranged coaxially.

14. The valve as claimed in claim 13,
wherein the second spring has a smaller diameter than the at least one first spring.

15. The valve as claimed in claim 14,
wherein the at least one first spring is supported on a base of the closure element and the second spring is supported on a collar inside the at least one first spring and concentric thereto, and a stop is arranged on the base of the closure element and is in contact with the collar during compression of the second spring.

16. The valve as claimed in claim 10,
wherein the spring device comprises a single spring which can be compressed at the first spring rate up to an intermediate position of the closure element and then at the second spring rate, wherein the first spring rate is smaller than the second spring rate.

17. The valve as claimed in claim 10,
wherein the electromagnetic actuator unit is configured to exert either a first force F₁ or a second force F₂ on the armature, wherein F₁ is not equal to F₂.

18. A motor vehicle comprising:
a turbocharger device comprising:
an intake side with a compressor; and
a turbine side with a turbine;
a bypass line to the compressor is provided on the intake side;
a valve is arranged in the bypass line configured to release or block the bypass line comprising:
an electromagnetic actuator unit;
an armature configured to be moved axially by the electromagnetic actuator unit;
a closure element connected to the armature and configured to block and release a flow path;
a housing that receives at least the armature and a first axial end of the closure element connected to the armature;
a spring device comprising:
at least one first spring that can be compressed at a first spring rate starting from a fully closed position of the valve up to a partially open intermediate position of the valve; and
a second spring that can be compressed at a second spring rate starting from a partially open intermediate position of the valve up to a fully open position of the valve,
wherein the first spring rate differs from the second spring rate; and
a housing part that forms a valve seat and against which a second axial end of the closure element is pressed by a spring device in a closed position of the valve.
